(19) United States
(12) Patent Application Publication
(10) Pub. No.: US 2006/0154113 A1
(43) Pub. Date: Jul. 13, 2006

(54) Perpendicular magnetic recording medium and magnetic recording device

(75) Inventors: Sadayuki Watanabe, Matsumoto City (JP); Yasushi Sakai, Matsumoto City (JP)

Correspondence Address: ROSSI, KIMMS & McDOWELL LLP., P.O. BOX 826, ASHBURN, VA, 20146-0826, US

(73) Assignee: Fuji Electric Device Technology Co., Ltd., Shinagawa-ku (JP)

(21) Appl. No.: 11/297,792

(22) Filed: Dec. 8, 2005

(30) Foreign Application Priority Data
Dec. 9, 2004 (JP) PA 2004-356239

(51) Int. Cl. G11B 5/65

(52) U.S. Cl. 428/836.2

(57) ABSTRACT

A perpendicular magnetic recording medium and a magnetic recording device with the medium are disclosed. Ferromagnetic crystal grains in a granular magnetic recording layer are grown with a constant grain diameter in a columnar shape, and the nonmagnetic grain boundaries comprise at least two types of oxides or nitrides, preferably of elements selected from Cr, Si, Al, Ti, Ta, Hf, Zr, Y, Ce, and B. The maximum G₁ of absolute values of standard Gibbs free energy of formation for oxidation of ferromagnetic elements composing the ferromagnetic crystal grains, the minimum G₂ and the second smallest G₃ of absolute values of standard Gibbs free energy of formation per 1 mol of oxygen molecules for oxidation of elements composing the nonmagnetic grain boundaries satisfy inequalities G₁<G₂<G₃ and (G₂−G₁)>(G₃−G₂) and G₃−G₂ is preferably smaller than 200 kJ/mol. The oxides can be replaced by nitrides, in which case the maximum G₁₁ of absolute values of standard Gibbs free energy of formation per one mole of nitrogen molecules in nitridation of ferromagnetic elements composing the ferromagnetic crystal grain, and the minimum G₁₂ and the second smallest G₁₃ of absolute values of standard Gibbs free energy of formation per one mole of nitrogen molecules in nitridation of elements composing the nonmagnetic grain boundary satisfy the following inequalities G₁₁<G₁₂<G₁₃ and (G₁₂−G₁₁)>(G₁₃−G₁₂), and G₁₃−G₁₂ is preferably smaller than 200 kJ/mol.

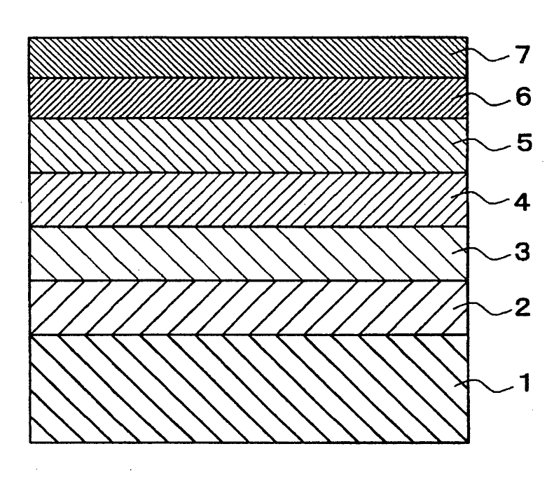

### CROSS REFERENCE TO RELATED APPLICATIONS

This application is based on, and claims priority to, Japanese Application No. 2004-356239, filed on Dec. 9, 2004, the contents of which are incorporated herein by reference.

### BACKGROUND OF THE INVENTION

A. Field of the Invention

The present invention relates to a perpendicular magnetic recording medium installed in magnetic recording devices and a magnetic recording device using the perpendicular magnetic recording medium, in particular to a perpendicular magnetic recording medium installed in a hard disk drive (HDD) and to a hard disk drive using the perpendicular magnetic recording medium.

B. Description of the Related Art

Recently, studies have been pursued on perpendicular magnetic recording systems as alternatives to the conventional longitudinal magnetic recording systems, as a technology to achieve high density magnetic recording. In these systems, the recording magnetization is perpendicular to a substrate surface. A perpendicular magnetic recording medium (also called simply a perpendicular medium) used for the perpendicular magnetic recording system mainly consists of a magnetic recording layer of a hard magnetic material, an underlayer for aligning the recording magnetization in the magnetic recording layer in the perpendicular orientation, a protective layer for protecting the surface of the magnetic recording layer, and a backing layer of a soft magnetic material for concentrating magnetic flux generated by a magnetic head used for recording on the recording layer. As is the case for a longitudinal magnetic recording medium, the compatibility between low noise and high thermal stability also is required for high recording density in a perpendicular medium.

Low noise can be achieved with minute and uniform ferromagnetic crystal grains and minimal magnetic interaction between the ferromagnetic crystal grains. The so-called “magnetic cluster size” is one of the indexes that includes an effect of the size of ferromagnetic crystal grains and represents a magnitude of the intergranular interaction. A magnetic cluster consists of a plurality of ferromagnetic crystal grains and a decreased magnetic cluster size is effective for noise reduction.

Various techniques have been proposed to decrease the magnetic cluster size. In the case of a magnetic recording layer of a CoCr-based alloy, which is also used in a longitudinal magnetic recording medium, it has been proposed to decrease the intergranular interaction by raising the nonmagnetic chromium concentration in the grain boundary (See Japanese Unexamined Patent Application Publication No. 2002-358615, for example). Because of limitations in segregating chromium to a grain boundary, a magnetic recording layer commonly called a granular magnetic recording layer has drawn attention recently as a technique for better isolation between ferromagnetic crystal grains and the reduction of intergranular interaction. Magnetic isolation characteristic between ferromagnetic crystal grains is ensured in the granular magnetic recording layer by composing the grain boundary between ferromagnetic crystal grains from oxide or nitride. In a perpendicular medium, a granular magnetic recording layer reportedly allows the intergranular interaction to be reduced while maintaining crystalline magnetic anisotropy at a high level compared with the former magnetic recording layer utilizing chromium segregation (T. Oikawa et al., “Microstructure and Magnetic Properties of CoPtCr—SiO₂ perpendicular Recording Media,” IEEE Transactions on Magnetics (USA), Vol. 38, No. 5, p. 1976-1978, September, 2002, for example). While oxide and nitride, which hardly cause solid solution into a ferromagnetic crystal grain, effectively isolate the ferromagnetic crystal grains by nature, in order to further promote isolation, a technique has been proposed in which Gibbs free energy of formation of the oxide or nitride is adjusted (Japanese Unexamined Patent Application Publication No. 2002-197633, for example). This technique focuses on standard Gibbs free energy of formation (ΔG) in oxidation or nitridation, and the ΔG for the element in ferromagnetic crystal grains is made to differ from the ΔG for the element in grain boundaries. An element(s) with larger absolute value of ΔG than the ΔG for element(s) composing the ferromagnetic crystal grains is used in the grain boundary so as to promote selective oxidation reaction or nitridation reaction. Thereby, only the oxide or nitride of an element(s) that is intended to compose the grain boundary is formed and segregation to the grain boundary is promoted to ensure isolation of the ferromagnetic crystal grains.

In order to reduce the magnetic cluster size, it is also effective to minimize the ferromagnetic crystal grains. Some proposals have been made that use an underlayer for this purpose (Japanese Unexamined Patent Application Publication No. 2001-134928, for example). An underlayer provided directly beneath a magnetic recording layer is principally used for vertically aligning ferromagnetic crystal grains. The underlayer having an isolation structure and a controlled grain size also controls a grain size of the magnetic recording layer formed on the underlayer.

According to the techniques described above, a magnetic recording layer, as macroscopically seen, has a minimized grain size on average, and promotes isolation of ferromagnetic crystal grains on average. In the precise analysis, however, there exist microscopic problems and the performance of the magnetic recording medium is rather deteriorated, as has been found in the study by the inventors.

A granular magnetic recording layer comprising ferromagnetic crystal grains increases its thickness by crystal growth. In the growth process, the grain size changes and branches occur, deteriorating performance. With the growth and increase of the film thickness, the grain diameter in the cross sectional plane parallel to the substrate increases and conjunction between adjacent ferromagnetic crystal grains may occur. Occasionally, a single ferromagnetic crystal grain grows and branches in the growth process, forming sub-grains. Even if the conjunction between the adjacent ferromagnetic crystal grains does not occur, when the distance between the grains decreases, intergranular interaction increases. When sub-grains are formed and the grain size becomes smaller than 4 nm, the grain looses its ferromagnetic property and does not contribute to magnetic performance.

The present invention is directed to overcoming or at least reducing the effects of one or more of the problems set forth above.

### SUMMARY OF THE INVENTION

The present invention has been made in view of the above problems and it is an object of the invention to provide a perpendicular magnetic recording medium and a magnetic recording device exhibiting improved magnetic recording performance by growing ferromagnetic crystal grains in a granular magnetic recording layer while keeping the grain size at a constant diameter and in a columnar shape.

According to the invention, a plurality of oxides or nitrides are used in the grain boundary that compose a granular magnetic recording layer, and standard Gibbs free energy of formation of these compounds is appropriately controlled, thereby achieving proper growth of the ferromagnetic crystal grains.

A perpendicular magnetic recording medium according to the invention comprises a magnetic recording layer provided on a nonmagnetic substrate, the magnetic recording layer including ferromagnetic crystal grains and nonmagnetic grain boundaries surrounding the crystal grains. The grain boundary is composed of at least two types of oxides. The maximum G₁ of absolute values of standard Gibbs free energy of formation per one mole of oxygen molecules in oxidation of ferromagnetic elements composing the ferromagnetic crystal grains, and the minimum G₂ and the second smallest G₃ of absolute values of standard Gibbs free energy of formation per one mole of oxygen molecules in oxidation of elements composing the nonmagnetic grain boundaries satisfy the following inequalities:
G₁<G₂<G₃ and (G₂-G₁)>(G₃-G₂).

Alternatively, the grain boundary is composed of at least two types of nitrides. The maximum G₁₁ of absolute values of standard Gibbs free energy of formation per one mole of nitrogen molecules in nitridation of ferromagnetic elements composing the ferromagnetic crystal grain, and the minimum G₁₂ and the second smallest G₁₃ of absolute values of standard Gibbs free energy of formation per one mole of nitrogen molecules in nitridation of elements composing the nonmagnetic grain boundary satisfy the following inequalities:
G₁₁<G₁₂<G₁₃ and (G₁₂-G₁₁)>(G₁₃-G₁₂).
G₃-G₂ is preferably smaller than 200 kJ/mol.
G₁₃-G₁₂ is preferably smaller than 200 kJ/mol.

The nonmagnetic grain boundary preferably consists of oxides or nitrides of at least two types of elements selected from Cr, Si, Al, Ti, Ta, Hf, Zr, Y, Ce, and B, and the ferromagnetic crystal grain preferably contains cobalt and platinum.

Advantageously, an underlayer is provided between the nonmagnetic substrate and the magnetic recording layer. The underlayer preferably consists of an element selected from Ru, Rh, Os, Ir, and Pt, or an alloy containing at least 50 at % of an element selected from Ru, Rh, Os, Ir, and Pt. Preferably, a seed layer is provided directly beneath the underlayer.

A magnetic recording device exhibiting good recording performance can be provided by a magnetic recording device that uses such a perpendicular magnetic recording medium. In a perpendicular magnetic recording medium having a construction as described above, a nonmagnetic grain boundary holds a constant thickness from the initial stage to final stage of growth even with a thick magnetic recording layer, and a ferromagnetic crystal grain grows with an approximately constant grain diameter. The result is suppression of conjunction between adjacent ferromagnetic crystal grains and suppression of the occurrence of sub-grains. As a result, the dispersion of grain diameter distribution of the ferromagnetic crystal grains is decreased, both homogenizing and minimizing the grain diameters. Improvement in the uniformity of grain boundary width reduces the required quantity of nonmagnetic grain boundary component and raises a packing factor of ferromagnetic crystal grains per unit area. Consequently, a signal to noise ratio (SNR) is raised and at the same time, the resistance to thermal fluctuation is improved, providing a perpendicular magnetic recording medium and a magnetic recording device with enhanced recording density.

Some preferred embodiments of the invention will be described below with reference to the accompanying drawing.

### BRIEF DESCRIPTION OF THE DRAWINGS

The foregoing advantages and features of the invention will become apparent upon reference to the following detailed description and the accompanying drawings, of which:

The sole drawing FIGURE is a schematic sectional view illustrating a structure of a perpendicular magnetic recording medium of an embodiment example according to the invention.

### DETAILED DESCRIPTION OF SPECIFIC EMBODIMENTS

The sole FIGURE of drawing illustrates an embodiment example of a structure of a perpendicular magnetic recording medium according to the invention.

The medium of the example is a so-called double layer perpendicular medium having a soft magnetic backing layer. The perpendicular magnetic recording medium comprises soft magnetic backing layer 2, seed layer 3, underlayer 4, magnetic recording layer 5, and protective layer 6 sequentially formed on nonmagnetic substrate 1. On protective layer 6, lubricant layer 7 is formed.

Nonmagnetic substrate 1 (nonmagnetic base plate) of a perpendicular magnetic recording medium of the invention can be composed of a Ni—P plated aluminum alloy, chemically strengthened glass, or crystallized glass that are used in a common magnetic recording medium. When the heating temperature for the substrate is not higher than 100° C., the substrate can be a plastic substrate made from a resin such as polycarbonate, polyolefin, or the like. In addition, a silicon substrate can also be used.

Soft magnetic backing layer 2 is preferably formed for improving read-write performance by controlling the magnetic flux generated by a magnetic head used for magnetic recording, although the soft magnetic backing layer may be omitted. The soft magnetic backing layer can be composed of a crystalline substance selected from a NiFe alloy, a Sendust (FeSiAl) alloy, a CoFe alloy and the like, or an amorphous substance selected from FeTaC, CoFeNi, CoNiP, and the like. Large saturation magnetization is preferred for the soft magnetic backing layer to enhance recording capability. In the case of a crystalline substance of a NiFe alloy or a CoFe alloy, at least 20 at % iron is contained for this purpose. Superior electromagnetic conversion characteristics can be attained by using an amorphous cobalt alloy for example, CoNbZr or CoTaZr. To obtain a large saturation magnetization, the cobalt content is preferably at least 80 at %. The optimum thickness of the soft magnetic backing layer depends on the structure and characteristics of a magnetic head used for magnetic recording. In the case of formation in sequential deposition processes for other layers, a desirable thickness is in a range of 10 nm to 500 nm in order to balance thickness with productivity. Nevertheless, when a soft magnetic backing layer is deposited in advance on the nonmagnetic substrate by means of a plating method, for example, before deposition of other layers, the thickness is not confined in this range, and a thick film of several hundred nm to several μm may be formed.

Seed layer 3 is preferably formed directly beneath the underlayer for the purposes of improving alignment and minimizing grain diameter in the underlayer. Seed layer 3 may be omitted. Seed layer 3 can be formed using either a nonmagnetic material or a soft magnetic material. From the viewpoint of recording capability, the distance between a magnetic head and a soft magnetic layer is desired to be a minimum. Consequently, a soft magnetic material is preferred for use in seed layer 3 so as to function equivalently to a soft magnetic backing layer. In the case of a nonmagnetic material, it is desired that the seed layer be as thin as possible. A material for seed layer 3 exhibiting a soft magnetic property can be selected from Ni-based alloys such as NiFe, NiFeNb, NiFeSi, NiFeB, and NiFeCr. Soft magnetic materials that can be used for seed layer 3 further include a single element of cobalt, cobalt-based alloys such as CoB, CoSi, CoNi, CoFe, and CoNiFe and CoNiFeSi. A preferred crystal structure is hcp or fcc. In an iron-containing material, the iron content is preferably at most 20 at % because a large content of iron is apt to form a bcc structure. A material for seed layer 3 that exhibits nonmagnetic property can be selected from a nickel-based alloy such as NiP, a cobalt-based alloy such as CoCr, and tantalum and titanium.

Underlayer 4 is preferably formed directly beneath magnetic recording layer 5 in order to appropriately control crystal alignment, crystal grain diameter, grain diameter distribution, and grain boundary segregation. The underlayer preferably has a crystal structure of hcp or fcc because crystal grains in magnetic recording layer 5 consist principally of cobalt and take an hcp or fcc structure. Preferred materials for underlayer 4 include Ru, Rh, Os, Ir, and Pt as well as an alloy containing at least 50 at % of Ru, Rh, Os, Ir, or Pt.

A magnetic recording layer has a columnar structure in which ferromagnetic crystal grains are surrounded by nonmagnetic grain boundaries. Here, “surrounded” means, on observation of the magnetic recording layer in a cross sectional plane parallel to the nonmagnetic substrate, adjacent ferromagnetic crystal grains are not in contact with each other and are isolated by a grain boundary composed of a nonmagnetic substance. This structure can be a construction in which ferromagnetic crystal grains grow directly from the layer beneath the magnetic recording layer, an underlayer, for example; and this structure does not necessarily mean the existence, between the ferromagnetic grains and the underlayer, of a nonmagnetic substance composing the nonmagnetic grain boundary of the magnetic recording layer. A similar relationship is valid between the ferromagnetic grains and the layer formed directly on the magnetic recording layer. This structure does not prohibit a situation in which ferromagnetic crystal grains are in contact with each other with very small probability.

The nonmagnetic grain boundary comprises two types of oxides or two types of nitrides. In the case where the grain boundary contains oxides, comparing (ΔG)s per one mole of oxygen molecules of each ferromagnetic element composing the ferromagnetic crystal grains, G, is defined by the maximum among absolute values of the (ΔG)s. The elements used for the nonmagnetic grain boundaries exhibit an absolute value of ΔG per one mole of oxygen molecules larger than G₁. At least two types of elements are used for the nonmagnetic grain boundaries, and the elements are selected so as to satisfy an inequality (G₂-G₁)>(G₃-G₂), where G₂ and G₃ are the minimum and the second smallest, respectively, among absolute values of (ΔG)s of the elements. Advantageously, G₃-G₂<200 kJ/mol.

In the case of a grain boundary of nitrides, comparing (ΔG)s per one mole of nitrogen molecules of each ferromagnetic element composing the ferromagnetic crystal grains, G₁₁ is defined by the maximum among absolute values of the (ΔG)s. The elements used for the nonmagnetic grain boundaries exhibit an absolute value of ΔG per one mole of nitrogen molecules larger than G₁₁. At least two types of elements are used for the nonmagnetic grain boundaries and the elements are selected so as to satisfy an inequality (G₁₂-G₁₁)>(G₁₃-G₁₂), where G₁₂ and G₁₃ are the minimum and the second smallest, respectively, among absolute values of (ΔG)s of the elements. Advantageously, G₁₃-G₁₂<200 kJ/mol.

Separation between the ferromagnetic crystal grains and the nonmagnetic grain boundaries can be enhanced by utilizing a large difference between the ΔG for the element composing the ferromagnetic crystal grains and the ΔG for the element composing the nonmagnetic grain boundaries. However, stable formation of a nonmagnetic grain boundary cannot be achieved solely by this means. If the component used to form the nonmagnetic grain boundary is only one type, then the nonmagnetic substance, though it precipitates to the grain boundary still holds relatively high energy and readily moves by surface migration. As a result, the widths of the grain boundaries are hardly kept uniform. On the other hand, when the components to form nonmagnetic grain boundary are of two or more types, oxygen atoms readily transfer between the components of the nonmagnetic grain boundary, losing migration energy obtained in the deposition process. The ultimately formed oxides hardly move off the grain boundary. Thus, the widths of the grain boundaries are kept uniform. When the difference between (ΔG)s of the grain boundary components is smaller than 200 kJ/mol, this effect is more significant. While the above description relates to oxides, the same reasoning is applicable in the case of nitrides.

Advantageously, at least two elements selected from Cr, Si, Al, Ti, Ta, Hf, Zr, Y, Ce, and B are used in the nonmagnetic grain boundaries. Table 1 gives the values of (ΔG)s per one mole of oxygen molecules for these elements. The values have been obtained based on the reference: “Kagaku Binran—Kiso II (in Japanese)” (Chemical Data Handbook—volume Basic Data II), revised 3rd edition, edited by The Chemical Society of Japan, pages 305-313. (For example, the reference gives the value −1058 kJ/mol for standard Gibbs free energy of formation of Cr₂O₃. From this value, ΔG per one mole of oxygen is calculated to be −705 kJ/mol, which is the above value (−1058 kJ/mol) for Cr₂O₃ multiplied by ⅔.) The ferromagnetic crystal grains preferably contain at least cobalt and platinum.

TABLE 1

| element | ΔG of oxidation (kJ/mol) |
|---|---|
| Cr | −705 |
| Si | −857 to −855 |
| Al | −1055 |
| Ti | −990 to −885 |
| Ta | −1274 |
| Hf | −1027 |
| Zr | −1043 |
| Y | −1151 |
| Ce | −1137 to −1025 |
| B | −796 |
| Co | −428 |

Protective layer 6 according to the invention may be a commonly employed protective layer, and can be a protective layer mainly consisting of carbon. Lubricant layer 7 can also be composed of a commonly used material, for example, a liquid lubricant of perfluoropolyether. Thicknesses and other conditions of the protective layer and the lubricant layer can be set at the conditions usually employed in common magnetic recording media.

Some specific embodiment examples of perpendicular magnetic recording media according to the invention will be described in the following. These examples are, however, merely for appropriately describing a perpendicular magnetic recording medium of the invention, and the invention shall not be limited to the examples.

### EXAMPLE 1

A substrate used was a chemically strengthened glass substrate having a smooth surface (N-5 glass substrate manufactured by HOYA Corporation). After cleaning, the substrate was introduced into a sputtering apparatus and soft magnetic backing layer 2 of amorphous CoZrNb having a thickness of 150 nm was formed under an argon gas pressure of 5 mTorr using a target of Co5Zr6Nb. (Each numeral represents the content in at % of the following element, that is, 5 at % of Zr, 6 at % of Nb, and the remainder of Co; the same representation is applicable in the descriptions below.) Subsequently, soft magnetic CoNiFeSi seed layer 3 having a thickness of 10 nm was formed under an argon gas pressure of 30 mTorr using a target of Co30Ni5Fe5Si. Then, ruthenium underlayer 4 having a thickness of 10 nm was deposited under a gas pressure of 30 mTorr using ruthenium. After that, magnetic recording layer 5 of CoPt—SiO₂—Cr₂O₃ having a thickness of 15 nm was deposited under an argon gas pressure of 60 mtorr using a target of 93 mol % (Co18Pt)-5 mol % (SiO₂)-2 mol % (Cr₂O₃). Finally, protective layer 6 of carbon having a thickness of 4 nm was deposited using a carbon target and then the substrate having these layers was taken out from the vacuum chamber. After that, liquid lubricant layer 7 of perfluoropolyether having a thickness of 2 nm was formed by a dipping method. All the layers except for the lubricant layer were deposited by means of a DC magnetron sputtering method. Substrate heating treatment was not conducted.

### EXAMPLE 2

A perpendicular medium of Example 2 was manufactured in the same manner as in Example 1 except that magnetic recording layer 5 was deposited using a target of 95 mol % (Co17.2Pt4.2Cr)-5 mol % (SiO₂) and a mixed gas of argon and 4 wt % oxygen.

### COMPARATIVE EXAMPLE 1

A perpendicular medium of Comparative Example 1 was manufactured in the same manner as in Example 1 except that magnetic recording layer 5 was deposited using a target of 93 mol % (Co18Pt)-7 mol % (SiO₂).

### COMPARATIVE EXAMPLE 2

A perpendicular medium of Comparative Example 2 was manufactured in the same manner as in Example 1 except that magnetic recording layer 5 was deposited using a target of 93 mol % (Co18Pt)-7 mol % (Cr₂O₃).

The evaluation results on the microstructure of the magnetic recording media of Examples and Comparative Examples are first described. On each of the perpendicular media of Examples and Comparative Examples, the surface observation and cross sectional observation were conducted by TEM (transmission electron microscope), and the composition analysis was conducted by XPS (X-ray photoelectron spectroscopy) and TEM-EDX (energy dispersion X-ray analysis).

<Cross Sectional Structure of the Magnetic Recording Layer>

The cross sectional observation by the TEM confirmed that the grain boundary widths are nearly constant and the ferromagnetic crystal grains are columnar in Examples 1 and 2. On the other hand, in Comparative Examples 1 and 2, the grain boundary widths tended to vary. The variation of grain boundary width in the thickness direction of a magnetic recording layer was evaluated from the cross sectional image by the TEM in the following way. Observation was made in five locations in the substrate surface and in a range of 1.0 μm along the substrate surface in each location. Thus, a total of 80 to 100 grain boundaries were extracted randomly. Then, for each grain boundary, a variation rate of the grain boundary width is calculated. The calculation method for the variation rate of grain boundary width for one grain boundary is as follows. A grain boundary is divided into 15 sections with a 1 nm pitch. A grain boundary width of the grain boundary is defined by the average of the widths of the grain boundary at these 15 points. A minimum variation rate and a maximum variation rate of the grain boundary are defined by the differential ratio of the minimum width or the maximum width in the 15 points to the average grain boundary width, respectively. The resulting values of the minimum variation rate and the maximum variation rate were averaged over the extracted 80 to 100 grain boundaries. The thus obtained variations of grain boundary width are given in Table 2. In Examples 1 and 2, the variations of grain boundary width are within ±5%, a very small value, showing growth with a constant width. In Comparative Examples 1 and 2, in contrast, the variations of grain boundary width are large values of −21% to +25%.

TABLE 2

| | Variation of grain boundary width (minimum |
|---|---|
| | variation rate/ |
| | maximum variation rate) |
| | (%) |
| Example 1 | −5/+4 |
| Example 2 | −3/+5 |
| Comparative Example 1 | −22/+24 |
| Comparative Example 2 | −21/+25 |

<Grain Diameter, Grain Boundary Width, Grain Diameter Dispersion of Magnetic Recording Layer>

From planar TEM images of a magnetic recording layer, an average grain diameter d, a grain boundary width t, dispersion of grain diameters σ/d (σ is a standard deviation of grain diameter distribution), and a number of grains per unit area were calculated. More specifically, using a planar TEM image in the region of 0.1×0.1 μm, an average grain diameter d and a number of grains per unit area T were obtained by averaging the areas of crystal grains in that region. From the planar TEM image, a grain boundary width t was obtained by tracing the grain boundaries and using an image analysis apparatus; the grain boundary width t being defined by:
t=((area of grain boundaries/number of measured crystal grains)/average perimeter of crystal grains)×2.

The results are shown in Table 3. Among the Examples and Comparative Examples, the average grain diameters are approximately equivalent, but the average grain boundary width, grain diameter dispersion, and the number of grains per unit area is different. The average grain boundary widths in Examples 1 and 2 are about 20% smaller than in Comparative Examples 1 and 2. The numbers of grains per unit area are 1.4 to 1.6 times in Examples 1 and 2 compared with those in Comparative Examples 1 and 2. The values of grain diameter dispersion are small values of 0.16 to 0.18 in Examples 1 and 2 while they are large values of 0.32 to 0.35 in Comparative Examples 1 and 2. Regarding the grain diameter dispersion, taking the above-described cross sectional observation into account, because the variation of grain boundary width is large in Comparative Examples 1 and 2, conjunction between adjacent grains and generation of sub-grains may occur, resulting in a very large dispersion of grain diameters. Since (ΔG)s per one mole of oxygen molecules for cobalt, chrome, and silicon are: ΔG_{Co}=−428 kJ/mol, ΔG_{Cr}=−705 kJ/mol, ΔG_{Si}−857 to −855 kJ/mol, respectively, oxygen bonds to these elements more easily in the order of Si>Cr>>Co. Consequently, in Comparative Examples 1 and 2, silicon or chrome, having a very large absolute value of ΔG compared to cobalt, immediately bond to oxygen in the deposition process and precipitate to the grain boundary. Nevertheless, the precipitated substance still holds a relatively high energy and easily moves by surface migration. Therefore, the grain boundary width is hardly kept constant. On the other hand, in the case of two types of grain boundary components, silicon and chromium, the difference of the ΔG between the nonmagnetic grain boundary components is about 150 kJ/mol, which is smaller than the large difference of more than 270 kJ/mol relative to cobalt. As a result, transfer of oxygen atoms predominantly occurs between the nonmagnetic grain boundary components, thereby losing energy. Thus, the ultimately formed oxides scarcely move from the grain boundary and the grain boundary width is kept constant.

TABLE 3

| | | average | | |
|---|---|---|---|---|
| | average | grain | | |
| | grain | boundary | grain diameter | number of grains |
| | diameter | width | dispersion | per unit area |
| | d [nm] | t [nm] | σ/d | T [grains/inch²] |
| Example | 6.74 | 0.95 | 0.18 | 16.2 |
| 1 | | | | |
| Example | 6.69 | 0.93 | 0.16 | 15.8 |
| 2 | | | | |
| Comp Ex | 6.72 | 1.12 | 0.32 | 11.3 |
| 1 | | | | |
| Comp Ex | 6.70 | 1.14 | 0.35 | 10.9 |
| 2 | | | | |

<Composition Analysis of a Magnetic Recording Layer>

To identify substances existing in the grain boundary, in particular, the analyses using XPS and TEM-EDX were conducted. First, the XPS surface analysis (spot diameter: 10 μm) confirmed that both silicon oxide and chromium oxide exist in the case of Examples 1 and 2. On the other hand, only silicon oxide exists in Comparative Example 1, and only chromium oxide exists in Comparative Example 2. Next, to compare compositions in the crystal grain and in the grain boundary, element analyses for Co, Pt, Si, and Cr were conducted by TEM-EDX (spot diameter: 1 nm). The measurements were conducted by point analysis. Specifically by extracting 20 points from the crystal grains and 20 points from the grain boundaries, measurement values were obtained by averaging the data repeatedly measured 5 times at every point. It has been found that, in Example 1, silicon and chromium are present in 3 to 4 times the amount in the grain boundary as compared to that in the crystal grains. In Example 2, silicon is present in 3 to 4 times the amount in the grain boundary as compared to that in the crystal grains, while chromium exists in an approximately equal amount in the grain boundary and in the crystal grains. In Comparative Example 1, silicon was detected in an amount of about 5 times in the grain boundaries as compared to in the crystal grains. In Comparative Example 2, chromium was detected in about 5 times the amount in the grain boundaries compared to that in the crystal grains. Since the spot of the TEM-EDX, having a diameter near the grain boundary width, may fall on a part of the crystal grain, an accurate composition can hardly be identified. Nevertheless, it can be considered that both silicon oxides and chromium oxides are segregated into the grain boundaries in Examples 1 and 2, while silicon oxides are segregated into grain boundaries in Comparative Example 1 and chromium oxides are segregated into grain boundaries in Comparative Example 2.

<Performance Evaluation of a Magnetic Recording Medium>

Next, studies were made on effects of the structure of a magnetic recording layer described previously on the magnetic cluster size and the electromagnetic conversion performance of a magnetic recording medium. The magnetic cluster size was derived, assuming a cylindrical shape, from an image obtained by observing the medium surface after AC demagnetization by a magnetic force microscope (MFM). Approximating a magnetization inversion unit in the image to a disk shape, the diameter of the disk was taken as a magnetic cluster size. As an evaluation of the electromagnetic conversion performance, SNR was measured using a spin-stand tester installing a single magnetic pole/GMR head. A signal degradation rate was obtained by measuring the time decay in 10,000 sec of output signals written at a linear recording density of 100 kFCl (kilo flux change per inch).

Table 4 shows the data of the magnetic cluster size and the SNR for the Examples and Comparative Examples. The data of the SNR in Table 4 are examples measured at a linear recording density of 600 kFCl. It has been confirmed that the relative superiority of the SNR does not alter with changes in the recording density.

TABLE 4

| | magnetic cluster size [nm] | SNR [dB] |
|---|---|---|
| Example 1 | 23.4 | 15.9 |
| Example 2 | 24.6 | 15.6 |
| Comparative Example 1 | 36.1 | 13.0 |
| Comparative Example 2 | 37.9 | 12.5 |

The magnetic cluster sizes in Examples 1 and 2 are small values, about ⅔ of those in Comparative Examples 1 and 2. Considering the microstructure obtained in the cross sectional and planar observations by the TEM as described previously, since the grain boundary width is constant along the thickness direction in Examples 1 and 2, the ferromagnetic crystal grains are well isolated from each other and the magnetic interaction between the ferromagnetic crystal grains is small. In Comparative Examples 1 and 2, in contrast, since the grain boundary width varies along the thickness direction, the intergranular interaction increases due to strong influence of a portion with narrow distance between grains, resulting in larger magnetic cluster size than in Examples 1 and 2. The SNR is higher in Examples 1 and 2 by more than 2.5 dB than in Comparative Examples 1 and 2. This is because the media noise is reduced in Examples 1 and 2 as compared to that in Comparative Examples 1 and 2, showing the effect of reduction in magnetic cluster size. The signal degradation was found to be nil in all the Examples 1 and 2 and Comparative Examples, indicating satisfactory resistance to thermal fluctuation. In Examples 1 and 2, despite the relatively small magnetic cluster size, the resistance to thermal stability is good. This is because the number of grains per unit area is large and the grain diameter dispersion is reduced, which means the number of extremely fine grains that do not exhibit ferromagnetic property is small and the substantial packing factor of the grains is large.

As described thus far, the effects of the present invention have been demonstrated. Although the grain boundary components are a combination of silicon oxide and chromium oxide in the examples described above, the same effects can be obtained by any combination of at least two types of oxides or nitrides of the elements selected from Cr, Si, Al, Ti, Ta, Hf, Zr, Y, Ce, and B. The same effects can be obtained by a varied ratio of the two or more types of grain boundary components. The same effects also can be obtained with ferromagnetic crystal grains of CoPtB, CoPtCrB, or CoPtCrSi, as well as CoPt and CoPtCr. In addition, variations in the seed layer and the soft magnetic backing layer are also possible within the invention.

Thus, a perpendicular magnetic recording medium and device have been described according to the present invention. Many modifications and variations may be made to the techniques and structures described and illustrated herein without departing from the spirit and scope of the invention. Accordingly, it should be understood that the media, devices and methods described herein are illustrative only and are not limiting upon the scope of the invention.

What is claimed is:

1. A perpendicular magnetic recording medium comprising:
a magnetic recording layer on a nonmagnetic substrate, the magnetic recording layer comprising ferromagnetic crystal grains and nonmagnetic grain boundaries surrounding the ferromagnetic crystal grains and consisting substantially of at least two types of oxides
wherein a maximum G₁ of absolute values of standard Gibbs free energy of formation per 1 mol of oxygen molecules for oxidation of ferromagnetic elements composing the ferromagnetic crystal grains, and a minimum G₂ and a second smallest G₃ of absolute values of standard Gibbs free energy of formation per 1 mol of oxygen molecules for oxidation of elements composing the nonmagnetic grain boundaries satisfy inequalities G₁<G₂<G₃ and (G₂-G₁)>(G₃-G₂).

2. A perpendicular magnetic recording medium comprising:
a magnetic recording layer on a nonmagnetic substrate, the magnetic recording layer comprising ferromagnetic crystal grains and nonmagnetic grain boundaries surrounding the ferromagnetic crystal grains and consisting substantially of at least two types of nitrides
wherein a maximum G₁₁ of absolute values of standard Gibbs free energy of formation per 1 mol of nitrogen molecules for nitridation of ferromagnetic elements composing the ferromagnetic crystal grains, a minimum G₁₂ and a second smallest G₁₃ of absolute values of standard Gibbs free energy of formation per 1 mol of nitrogen molecules for nitridation of elements composing the nonmagnetic grain boundaries satisfy inequalities G₁₁<G₁₂<G₁₃ and (G₁₂-G₁₁)>(G₁₃-G₁₂).

3. The perpendicular magnetic recording medium according to claim 1, wherein G₃-G₂<200 kJ/mol.

4. The perpendicular magnetic recording medium according to claim 2, wherein G₁₃-G₁₂<200 kJ/mol.

5. The perpendicular magnetic recording medium according to claim 1, wherein the nonmagnetic grain boundary substantially consists of at least two types of oxides or at least two types of nitrides of elements selected from Cr, Si, Al, Ti, Ta, Hf, Zr, Y, Ce, and B.

6. The perpendicular magnetic recording medium according to claim 2, wherein the nonmagnetic grain boundary substantially consists of at least two types of oxides or at least two types of nitrides of elements selected from Cr, Si, Al, Ti, Ta, Hf, Zr, Y, Ce, and B.

7. The perpendicular magnetic recording medium according to claim 3, wherein the nonmagnetic grain boundary substantially consists of at least two types of oxides or at least two types of nitrides of elements selected from Cr, Si, Al, Ti, Ta, Hf, Zr, Y, Ce, and B.

8. The perpendicular magnetic recording medium according to claim 4, wherein the nonmagnetic grain boundary substantially consists of at least two types of oxides or at least two types of nitrides of elements selected from Cr, Si, Al, Ti, Ta, Hf, Zr, Y, Ce, and B.

9. The perpendicular magnetic recording medium according to claim 1, wherein the ferromagnetic crystal grains contain cobalt and platinum.

10. The perpendicular magnetic recording medium according to claim 2, wherein the ferromagnetic crystal grains contain cobalt and platinum.

11. The perpendicular magnetic recording medium according to claim 3, wherein the ferromagnetic crystal grains contain cobalt and platinum.

12. The perpendicular magnetic recording medium according to claim 4, wherein the ferromagnetic crystal grains contain cobalt and platinum.

13. The perpendicular magnetic recording medium according to claim 5, wherein the ferromagnetic crystal grains contain cobalt and platinum.

14. The perpendicular magnetic recording medium according to claim 1, further comprising an underlayer between the nonmagnetic substrate and the magnetic recording layer, the underlayer substantially consisting of an element selected from Ru, Rh, Os, Ir, and Pt or an alloy containing at least 50 at % of an element selected from Ru, Rh, Os, Ir, and Pt.

15. The perpendicular magnetic recording medium according to claim 14, further comprising a seed layer directly beneath the underlayer.

16. The perpendicular magnetic recording medium according to claim 2, further comprising an underlayer between the nonmagnetic substrate and the magnetic recording layer, the underlayer substantially consisting of an element selected from Ru, Rh, Os, Ir, and Pt or an alloy containing at least 50 at % of an element selected from Ru, Rh, Os, Ir, and Pt.

17. The perpendicular magnetic recording medium according to claim 16, further comprising a seed layer directly beneath the underlayer.

18. A magnetic recording device comprising the perpendicular magnetic recording medium defined by claim 1.

19. A magnetic recording device comprising the perpendicular magnetic recording medium defined by claim 2.
